(19) United States
(12) Patent Application Publication
(10) Pub. No.: US 2008/0124629 A1
(43) Pub. Date: May 29, 2008

(54) Electrodes for electrical power accumulators

(75) Inventors: Karsten Rieck, Nordhausen (DE); Stefan Theuerkauf, Nordhausen (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Dilo Trading AG, Zug (CH)

(21) Appl. No.: 11/985,998

(22) Filed: Nov. 19, 2007

(30) Foreign Application Priority Data
Nov. 29, 2006 (DE) 10 2006 035468.0

(51) Int. Cl. H01M 4/40; H01M 4/00

(52) U.S. Cl. 429/209; 429/231.95

(57) ABSTRACT

An electrode for electrical power accumulators, in particular lithium-ion batteries, has a structured surface. In one embodiment, the cathode electrode is implemented as structured, this structuring occurring at the same time as the production in a laminator. Capillaries are produced. Upon filling of the cell, these capillaries conduct the electrolytes, because of their capillary action, into the middle of the coiled cathode electrode, i.e., into the middle of the cell. It is thus possible to fill the lithium-ion cell in a single step.

### CROSS REFERENCE TO RELATED APPLICATION

This application claims benefit of German Patent Application No. 10 2006 035468.0, filed Nov. 28, 2006.

### BACKGROUND

Electrodes for electrical power accumulators and in particular for lithium-ion batteries are known in the prior art. These known electrodes do not have a rough, strongly textured surface structure.

For example, extrusion with subsequent lamination or application coating as a dispersion with subsequent drying is the prior art in the production of these electrodes, a softener sometimes being removed and being replaced by the electrolytes (see also “Lithium Ion Batteries”, M. Wakihara, O. Yamamoto, Wiley-VCh, Weinheim, 1998, page 235 and FIG. 10.9; or German Patent Specification DE 100 20 031 and corresponding US patent application No. 2004/0029008).

Filling electrical power accumulators, in particular lithium-ion cells, causes problems especially in large cells having outputs of 45 Ah. In typical cells having coiled electrodes, 60% to 70% of the required quantity of electrolytes is introduced using vacuum into the coil in a first step. Subsequently, the coil is stored for 5 to 10 hours. The electrolyte requires this time to penetrate into the pores of the wound electrodes. In the second step, the cell is evacuated once again and the remaining electrolyte quantity is introduced.

Problems arise in this method for filling a cell, in that the excess electrolyte from the first step may be drawn into the vacuum system. In addition, low-boiling components of the electrolytes (e.g., ethyl methyl carbonate, EMC) may vaporize upon renewed evacuation in the second step, so that the vapor pressure of the low-boiling components limits the degree of the vacuum.

In the method according to the prior art, complex cooling traps are required to protect the vacuum system. In addition, the cells must be temporarily stored after the first method step, which is time-consuming.

### SUMMARY

One object of the present invention is to provide improved electrodes for electrical power accumulators.

In particular, one intention of embodiments of the present invention is to provide structure-modified electrodes for electrical power accumulators, for example, for lithium-ion batteries.

According to one embodiment of the present invention, there is provided an electrode having a structured surface. The electrode is especially an electrode, and more especially a cathode, for a lithium-ion battery, but may be another electrode, for example, an electrode for a super capacitor, and may be an anode.

According to another embodiment of the present invention, there is provided a method of forming an electrode that comprises structuring an active surface of the electrode, either while creating the electrode or in a subsequent step.

According to another embodiment of the present invention, there are provided lithium ion batteries, super capacitors, and other devices incorporating at least one electrode having a structured surface in accordance with the invention, and/or obtained or obtainable by a method in accordance with the invention.

The structured surface may be a surface obtainable by reshaping, and this embodiment of the invention also includes methods that comprise reshaping to form the structured surface.

The structuring of the surface may run in one direction. In the case of a coiled cell battery or other device having a spiral or cylindrical shape, the structuring of the surface may then run in the axial direction when the electrode is rolled up into a coil.

The structuring of the surface may be fluting.

The structuring of the surface may be in the form of capillaries, and the invention may then include an embodiment of a method of making a battery, capacitor, or the like in which an electrolyte is drawn into the structured surface by capillary attraction. The capillaries may be obtained or of a shape obtainable, for example, by fluting the surface and calendering the fluting, or by rolling up a fluted electrode with the fluting on the inside, or by using a continuous laminator having an integrated roll pair having transverse grooves.

The structuring of the surface may have a profile depth of 1 μm to 2 μm.

The structuring of the surface may be obtained or obtainable by shaping or reshaping an electrode component at a temperature of 70° C. to 75° C.

It is to be understood that both the foregoing general description and the following detailed description are exemplary and explanatory and are intended to provide further explanation of the invention as claimed.

### BRIEF DESCRIPTION OF THE FIGURES OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic illustration of an electrode according to the present invention having a structured surface.

FIG. 2 is a schematic illustration of a preferred embodiment of the electrode according to the present invention, in which the structured surface is implemented in the form of capillaries.

### DETAILED DESCRIPTION

Reference will now be made in detail to various embodiments of the present invention, examples of which are illustrated in the accompanying drawings. The embodiments are described by way of explanation, and not by way of limitation.

Referring to the accompanying drawings, one embodiment of an electrode according to the present invention has a structured surface. Such structuring may be provided as inherent in a layer, for example, open pores may be present on the surface. On the other hand, the structuring may be performed by targeted reshaping of the surface.

Such targeted reshaping may be executed, for example, by planar embossing of a uniform structure. Another example is structuring in a preferred direction.

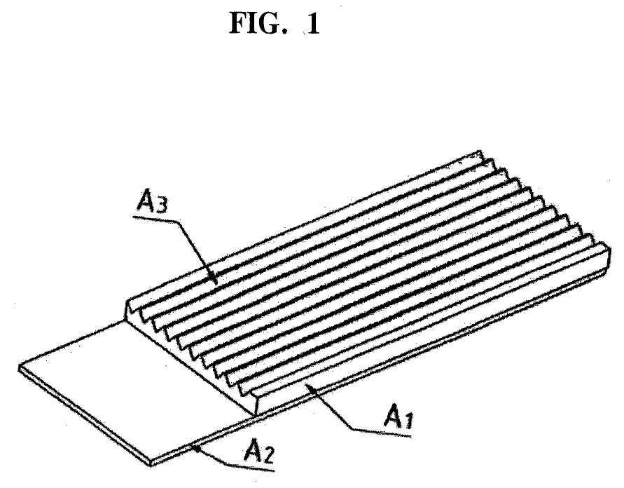

In one embodiment of the present invention, a cathode electrode is implemented as structured. This structuring occurs at the same time as the production in a laminator. Referring to FIG. 1, an electrode coating A1 is laminated onto a collector film A2 in a laminator. The cathode electrode thus laminated leaves the heated part of the laminator at a temperature of 70° C. to 75° C. At this temperature, the compound of the electrode coating is still soft and moldable. Profiling is embossed in the compound of the electrode coating by an integrated roll pair, which has a structured surface, at the outlet of the heated part of the laminator.

In a preferred refinement of the cathode electrode shown in the drawings, transverse grooves are introduced as the structuring by the integrated roll pair. The transverse grooves are preferably provided in the form of fluting A3, as shown in FIG. 1. The structured surface preferably has a profile depth of 1 μm to 2 μm.

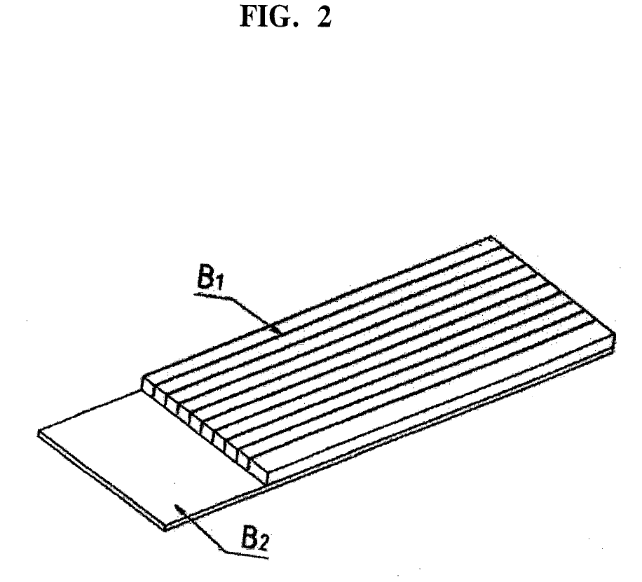

In a further preferred refinement of the cathode electrode shown in the drawings, the fluting A3 is reshaped into capillaries B1 (see FIG. 2) in an additional method step.

This reshaping of the capillaries may be performed, for example, by calendering of the structured surface. The fluting A3 is compacted by the calender rolls in such a way that the capillaries B1 result.

A further possibility for forming the capillaries is the direct rolling of the cathode electrode into an electrode coil. The rolling of the cathode electrode is preferably performed in such a way that the fluting A3 is brought into the interior (concave side) of the electrode coil. The fluting A3 is pressed inward by the winding up and thus compacted into capillaries B1.

In this case also, the capillaries preferably also have a profile depth of 1 μm to 2 μm.

The cathode electrode is preferably wound up in such a way that the structuring of the electrode surface runs in the axial direction.

The disadvantages of the prior art can be solved, or at least mitigated, by embodiments of the electrode according to the present invention.

During filling of the cell, the capillaries conduct the electrolytes, because of their capillary action, into the middle of the coiled cathode electrode, i.e., into the middle of the cell. It is thus possible to fill the lithium-ion ion cell in a single step.

Although the present invention was described in connection with a cathode electrode in particular, the present invention is also applicable for anode electrodes and electrodes for super capacitors.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electrode having a structured surface.

2. The electrode according to claim 1 for a lithium-ion battery.

3. The electrode according to claim 1, wherein the structuring of the surface is obtainable by reshaping.

4. The electrode according to claim 1, wherein the structuring of the surface runs in one direction.

5. The electrode according to claim 4 for a coiled-cell battery, wherein the structuring of the surface runs in the axial direction when the electrode is rolled up into a coil.

6. The electrode according to claim 4, wherein the structuring of the surface is fluting.

7. The electrode according to claim 1, wherein the structuring of the surface is in the form of capillaries.

8. The electrode according to claim 7, wherein the structuring of the surface is in the form of capillaries obtainable by fluting the surface and calendering the fluting.

9. The electrode according to claim 7, which is a coiled or tubular electrode wherein the capillaries are obtainable by rolling a fluted electrode with the fluting on the inside.

10. The electrode according to claim 1, wherein the structuring of the surface has a profile depth of 1 μm to 2 μm.

11. The electrode according to claim 1, wherein the structuring of the surface is obtainable using a continuous laminator having an integrated roll pair having transverse grooves.

11. The electrode according to claim 1, wherein the structuring of the surface is obtainable at a temperature of the electrode of 70° C. to 75° C.

12. The electrode for lithium-ion batteries according to claim 2, wherein the electrode is a cathode electrode for a lithium-ion battery.

13. A lithium-ion battery comprising at least one electrode having a structured surface.
